(19) United States
(12) Patent Application Publication
(10) Pub. No.: US 2009/0260995 A1
(43) Pub. Date: Oct. 22, 2009

(54) Polymer based biosensor

(76) Inventors: Keith Warriner, Guelph (CA); Asadeh Namvar, Guelph (CA)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(21) Appl. No.: 12/382,604

(22) Filed: Mar. 19, 2009

Related U.S. Application Data
(60) Provisional application No. 61/071,171, filed on Apr. 16, 2008.

(51) Int. Cl. G01N 27/26

(52) U.S. Cl. 205/778.5; 204/403.01; 205/775; 205/782

(57) ABSTRACT

A biosensor comprising a conducting polymer and a facilitating agent that combine to form a polymeric matrix that interacts with electrophilic compounds, wherein an electrochemical property of the polymer is altered in the presence of an electrophilic compound.

This application claims the benefit of U.S. Provisional Application No. 61/071,171 filed on Apr. 16, 2008.

### FIELD OF THE INVENTION

The present invention relates generally to the field of biosensors, and more particularly to a polymer-based sensor for detecting electrophilic compounds such as carcinogenic mycotoxins.

### BACKGROUND

Mycotoxin is a broad term used to describe toxic secondary metabolites derived from certain filamentous mold strains such as Aspergillus, Penicillium and Fusarium. Crops, pre- or post-harvest, that support the growth of molds can potentially become contaminated with mycotoxins, although cereals (for example, wheat, barley, maize, rye) and oilseeds are considered high risk commodities. A common feature of mycotoxins is their high binding affinity to DNA and proteins, a feature which can lead to chronic conditions such as cancer, immuno-suppression or organ damage. Mycotoxins are very stable and can accumulate within the body when ingested in small quantities over prolonged time periods. In animals (especially pigs), the production period is typically too short to result in chronic toxicity, however, even moderate levels can detrimentally effect their development.

Mycotoxins in plants result in lower yields and reduces the value of the crop produced. For example, in 1996 a Fusarium epidemic in Ontario affecting winter wheat resulted in direct losses of greater than $100 million. This was excluding the negative affects on animal production and long-term health implications to consumers.

Due to the stability of mycotoxins, there is no reliable method to inactivate or remove the toxic agent should contamination occur. There is a high reliance on sample screening to identify contaminated batches and restrict entry into the food chain; however, because mycotoxins represent a hazard even when present in trace amounts, regulatory limits are set in the parts per billion (ppb) and sample sizes are typically large (0.1-1 kg). Therefore, this necessitates initial extraction and concentration of mycotoxins from samples prior to detection using techniques such as HPLC or ELISA. Current methods are laboratory-based, require a high level of expertise and are time consuming. An ideal alternative is on-site screening for mycotoxins to provide rapid results and to permit immediate corrective action to take place (withdrawal or diversion of contaminated batches). Current on-site tests based on ELISA dip-sticks have complicated protocols and poor sensitivity. The mycotoxin levels in grains (such as wheat and corn) within Ontario are amongst the highest encountered in Canada. This is primarily due to the climatic conditions within the province that are conducive. to mycotoxin formation by contaminating molds.

There is a need, thus, for the development of improved methods of mycotoxin detection in food and other samples to ensure that mycotoxin contaminated samples are identified and dealt with appropriately.

### SUMMARY OF THE INVENTION

A novel biosensor has now been developed in which a conducting polymer is combined with a facilitating agent to form a complex that interacts with electrophilic compounds. Interaction with electrophilic compounds induces a detectable electrochemical change in the polymer.

Thus, in one aspect of the present invention, a biosensor is provided comprising a conducting polymer and a facilitating agent that combine to form a polymeric matrix that interacts with electrophilic compounds, wherein an electrochemical property of the polymer is altered in the presence of an electrophilic compound.

In another aspect of the present invention, a method of detecting an electrophilic compound in a sample is provided, comprising the steps of:
1) contacting the sample with a conducting polymer:facilitating agent matrix that interacts with electrophilic compounds, wherein the interaction alters an electrochemical property of the polymer; and
2) determining whether an electrochemical property of the polymer is altered, wherein a change in an electrochemical property of the polymer is indicative of the presence of an electrophilic compound in the sample.

These and other aspects of the invention are described by reference to the following detailed description and figures.

### BRIEF DESCRIPTION OF THE FIGURES

FIG. 1 graphically illustrates electrochemical changes (e.g. changes in conductance (Y′) and susceptance (Y″)) in a polymeric biosensor in accordance with an aspect of the invention;

FIG. 2 illustrates that the detection limit of the biosensor of FIG. 1 correlates with conductivity of the biosensor;

FIG. 3 illustrates an equivalent circuit for a patulin:polypyrrole biosensor (A) and simulation spectra (B) to verify equivalency;.

FIG. 4 graphically illustrates changes in Rs (A), Rp (B), CPE-T (C) and CPE-P (D) upon interaction of patulin with a patulin:polypyrrole biosensor;

FIG. 5 graphically illustrates the effect of repeated patulin (200 ppb) exposure to a patulin:polypyrrole biosensor and control polypyrrole on Rp (A), CPE-T (B) and CPE-P (C);

FIG. 6 is a schematic of the interaction of patulin with charge carrying polarons/bipolarons on the polypyrrole chains;

FIG. 7 graphically illustrates the response of a patulin:polypyrrole biosensor to 100 ppb patulin in (A) water and (B) reconstituted apple juice;

FIG. 8 illustrates the response of a DNA:polypyrrole biosensor to a crude extract of DON derived from spent culture medium of Fusarium graminearum; and

FIG. 9 illustrates the DVP response of a BSA:polypyrrole biosensor to different concentrations of patulin.

### DETAILED DESCRIPTION OF THE INVENTION

A biosensor useful to detect one or more electrophilic compounds in a sample is provided that comprises a conducting polymer and a facilitating agent to form a matrix that interacts with the electrophilic compound(s) and induces a detectable change in an electrochemical property of the polymer following interaction with the electrophilic compound.

The present biosensor comprises a suitable conducting polymer. As used herein, the term “conducting polymer” refers to polymers that possess electronic properties, such as conductivity. Suitable conducting polymers will possess redox potentials that render them resistant to oxidative degradation in air or aqueous solution, for example, redox potentials in the range of about −0.1-0.2V vs. Ag/AgCl. The conductivity of conducting polymers is related to the abundance of charge-carrying polarons (cation radicals) and bipolaron (di-cation) structures present on the polymer backbone. The conductivity of polymers is typically modulated by the oxidative state. As the oxidative state is increased, polarons and bipolarons are formed to give rise to conductivity. Examples of suitable conducting polymers include, but are not limited to, polypyrrole, polyaniline, polythiophene, polyacetylene, and derivatives thereof.

To form a biosensor, monomers of a selected conducting polymer are combined with a facilitating agent to form a polymeric matrix that interacts with the target electrophilic compound(s). The facilitating agent may be any compound that results in the formation of a conducting polymeric matrix that interacts with the target electrophilic compound(s) and induces a detectable change in an electrochemical property of the conducting polymer. Examples of facilitating agents include patulin and derivatives thereof, compounds having a molecular weight greater than 150 g/mol including pyrrole derivatives such as acyl, lactone, purine and pyrimadine derivatives, nucleophilic compounds particularly those suitable for reaction with the target electrophilic compound(s), nucleic acids, proteins such as BSA or amino acids such as cysteine or tyrosine.

Formation of the biosensor may be performed by electropolymerization of monomer units on an electrode coated with a facilitating agent using well-established conditions, for example, conducted in the presence of a doping ion/electrolyte such as ammonium chloride, an amount of monomer (such as pyrrole) of greater than 0.4M, an amount of facilitating agent of greater than 1 ppm and a Galvinostatic 70-100° C. charge passed during electropolymerization. Unreacted facilitating agent and other monomers are removed from the matrix using known techniques such as incubation with a compound suitable for this purpose such as an organoaluminum initiator, e.g. triethylaluminum. The biosensor may also be formed by chemical deposition on an inert surface. Once formed, the biosensor may be maintained on the electrode or other surface on which it was formed. Alternatively, it may be detached from the surface on which it was formed and utilized as a free-standing polymeric biosensor.

The polymeric matrix (biosensor) formed is reactive with and, therefore useful to detect, electrophilic compounds. As one of skill in the art will appreciate, the electrophilic compound that may be detected in accordance with the invention will vary with the parameters of the conducting polymer and the facilitating agent used to prepare the polymeric matrix, e.g. the nucleophilic characteristics thereof. Preferably, the present biosensor is useful to detect compounds known to be strong electrophilic compounds. The term “strong electrophilic compound” refers herein to a compound with increased oxidizing power, with an increased tendency to interact with electrons within the biosensor. In certain embodiments, particularly where the interaction results in the formation of covalent linkages (e.g. adduct formation), the electrophile may have a Dargo's Parameter that is exceeds 0.45. In other embodiments, the electrophile may have an electrophilicity index value of greater than ascorbic acid, e.g. an electrophilicity index value approaching that of patulin. Alternatively, the electrophile may have an electrophilicity index value of at least about 1.7.

, for example, compounds with an electrophilicity index of greater than that of ascorbic acid. Electrophilic compounds that may be detected in accordance with the present invention, thus, include, for example, mycotoxins such as aflatoxins, e.g. aflatoxin B1, ochratoxin A, patulin and fusarium toxins, e.g. fumonisins, trichothecenes including deoxynivalenol (DON), and zearalenone; and other carcinogens.

Reaction of the matrix with an electrophile results in a change in an electrochemical property of the conducting polymer, for example, a change in the conductivity of the polymer. The nature of the reaction between the electrophile and the matrix is not particularly restricted, and may differ depending on both the nature of the matrix and the electrophile.

In one embodiment, the combination of conducting polymer and facilitating agent may result in a matrix incorporating the facilitating agent that provides suitable inter-matrix sites for interaction with an electrophile, e.g. the formation of a covalent linkages between the matrix and the electrophile, to form an adduct in which detectable electrochemical changes result in the polymer.

In another embodiment, the combination of conducting polymer and facilitating agent may result in a matrix with high binding affinity for an electrophile. Binding of the electrophile to the matrix may then result in changes, e.g. formation of radicals, which alter an electrochemical property of the polymer.

Detection of a change in an electrochemical property of the polymer in the presence of an electrophile may be conducted using a wide variety of electrochemical techniques. For example, conductivity of the polymer may be determined by impedance spectroscopy, differential pulse voltammetry, amperometry, square wave voltammetry, and pulsed amperometric detection. As one of skill in the art will appreciate, changes in electrochemical properties may also result in other detectable changes in the polymer matrix. For example, electrochemical changes may be detected optically, by UV or infrared absorption, since light reflection of conducting polymers is related to polymer conductivity.

The present invention relates to a reagentless polymer-based biosensor for the detection of electrophiles, e.g. strong electrophiles, including carcinogenic mycotoxins in various samples such as crops (e.g. cereals/grains, legumes, fruits and vegetables, etc.), and in prepared foods and beverages.

The biosensor is based on monitoring electrochemical changes in supporting conducting polymers induced by the interaction with the electrophile. Reaction of the biosensor with the target electrophile results in a change in electrochemical properties of the polymer including conductivity and resistance as determined by monitoring impedance, for example. The change in impedance was found to be dependent on the applied bias potential (oxidative state) and electrophile concentration, with very low limits of detection, for example, limits of detection in the parts per billion, e.g. less than 100 ppb such as less than 50 ppb and preferably less than 20 ppb such as less than 10 ppb. Plain conducting polymer formed in the absence of a facilitating agent (plain films) did not exhibit a change in electrochemical properties on reaction with an electrophile. While not wishing to be bound by any particular theory as regards mode of action, electrochemical changes may result from interactions of the electrophile with charge-carrying bipolarons present in the biosensor matrix.

Embodiments of the invention are described in the following specific examples which are not to be construed as limiting.

### EXAMPLE 1

### Patulin Biosensor

Fabrication ofpatulin-polypyrrole matrix: The matrix was prepared by adsorbing the patulin (200-2000 ppb) onto the surface of a glassy carbon electrode. The electrode was then transferred to an electrochemical cell containing 0.1M pyrrole, 0.1M TBAP and 0.2M EDGMA with electropolymerization being initiated by applying a 0.85V vs Ag/AgCl bias potential until 70 μC charge had accumulated. The electrode was then submerged in 3% TEA for 10 minutes to release patulin and pyrrole monomers. Control films were prepared in the same way except that no patulin was adsorbed onto the electrode surface.

Impedance spectroscopy: Impedance spectroscopy was performed using a 1260 frequency response analyzer in conjunction with Zview software (Scriber). A 3-electrode system was used with the polypyrrole-modified electrode acting as the working electrode, platinum mesh as the counter electrode and Ag/AgCl as reference electrode. Impedance scans were performed over a frequency range of 0.1 Hz-100 kHz with an amplitude of 40 mV and appropriate bias potential. The supporting electrolyte was 0.1M KCl in all cases.

Patulin assay: Baseline impedance spectra were obtained for the patulin-polypyrrole electrodes. The electrode was then removed from the cell and placed in patulin solutions of different concentrations (20-2000 ppb) for 10 min. The sensor was then returned to the electrochemical cell and impedance spectra obtained. The electrode response was determined by subtracting the spectra following reaction with patulin from the background. Between each patulin measurement, the sensor was soaked in 3% TEA to elute non-reacted patulin.

### Results

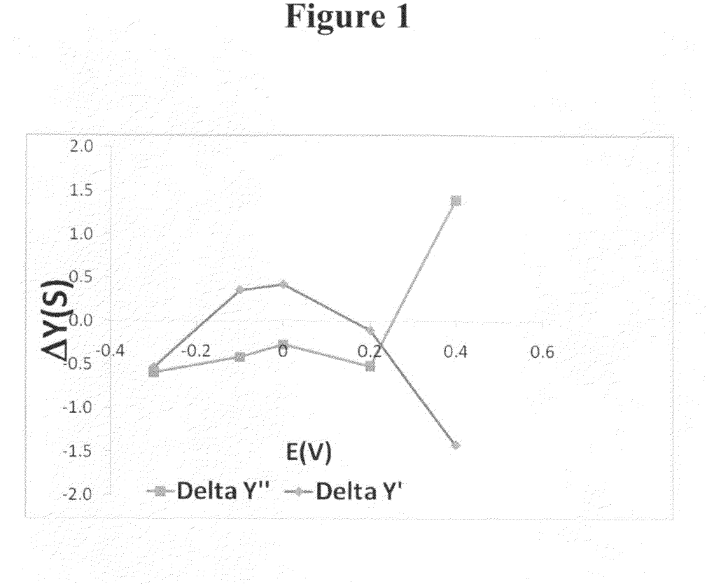

Patulin films were prepared by adsorbing the mycotoxin (200 ppb) onto the surface of a glassy carbon electrode prior to electrodeposition of pyrrole. Unbound patulin was eluted from the polypyrrole by soaking for 10 min in 3% TEA solution. The elution and re-binding of patulin was monitored using impedance spectroscopy (1-100 kHz 40 mV amplitude, 0 V bias potential). It was found that interaction of patulin with the polypyrrole layer resulted in a change in admittance (Y). The magnitude of the change in Y was dependent on the applied bias potential (FIG. 1). The most notable change was in the Y′ (conductance) and to a lesser extent Y″ (susceptance). At the extreme potentials (−0.3 and 0.4V) a negative change in Y′ was observed indicating that the polypyrrole film had become more resistant during the interaction with patulin. However, at intermediate bias potentials a positive increase in Y′ resulted with a maximal response lying between −0.1-0.0 V. The results can be interpreted in terms of the oxidative state of the polypyrrole. At −0.3V the polypyrrole is in a reduced and insulating state and thereby less likely to interact with the patulin target. However, as the bias potential increases, charge carrying polarons and bipolarons form on the polypyrrole chains which can interact with patulin to enhance the conductivity of the film. At 0.4V it is possible that the interaction with patulin resulted in over-oxidation of the polypyrrole leading to a reduced, non-conducting state.

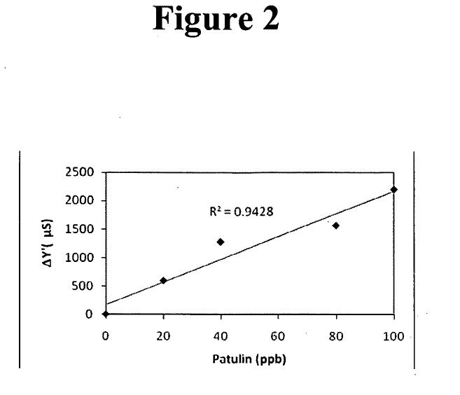

The change in Y″ was notable when the bias potential was poised at 0.4V. This is expected given that the capacitance of the film increases as the polypyrrole becomes more resistant due to over-oxidation effects. The change in Y′ of patulin-polypyrrole films could be correlated to the patulin concentration up to 100 ppb with a lower detection limit of less than 20 ppb (FIG. 2). In this experiment, the limit of detection is set at 3 times the base line. In the current sensor, the threshold would be >300 uS and so the actual detection limit is expected to be 10-15 ppb.

Unbound patulin was removed by soaking in 3% TEA for 20 min. Impedance spectroscopy was performed on the modified electrodes over a frequency range of 1-100 kHz using a bias potential of 0 V vs Ag/AgCl. The electrode was then exposed to solutions containing different patulin concentrations for 10 min and changes in Y′ determined.

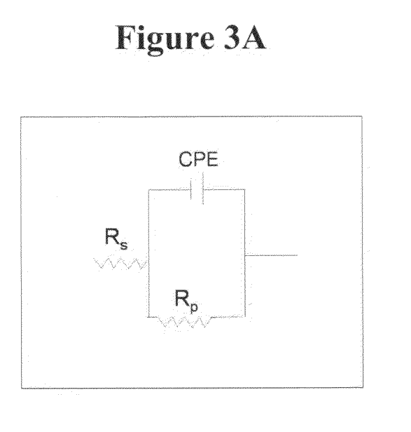

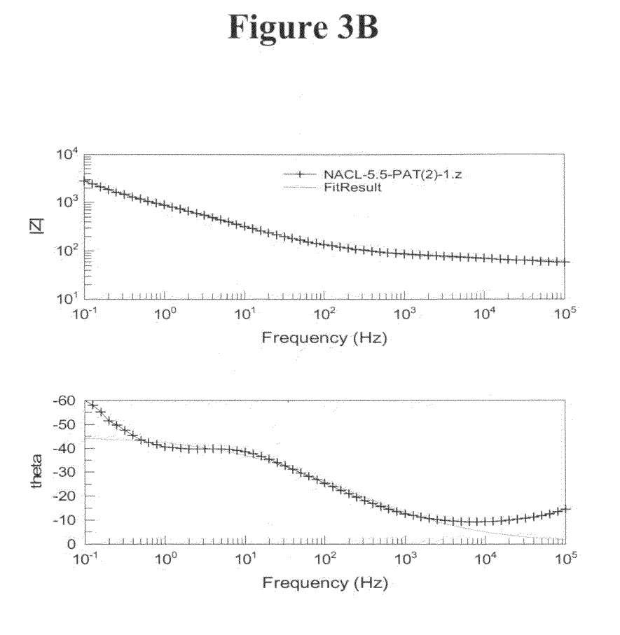

To probe further into the mechanistic action of patulin:polypyrrole interactions, an equivalent circuit was constructed that included solution resistance (Rs) in series with a parallel polymer resistant (Rp) and constant phase element (CPE) (FIG. 3A). The CPE is defined by two values, CPE-T and CPE-P. If CPE-P=1, than the equation is identical to that of a perfect capacitor. The CPE-P is included to take into account the time domain (diffusion of ions in the presence of an alternating field) which represents an imperfect, or leaky, capacitor.

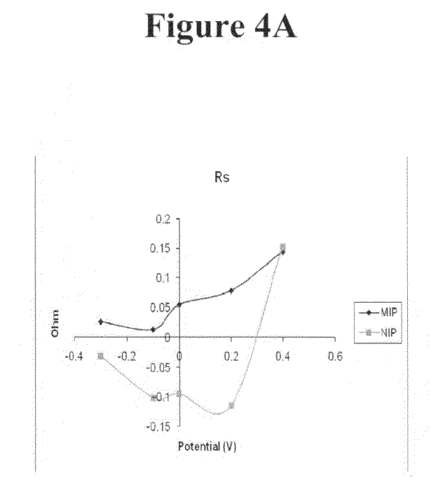

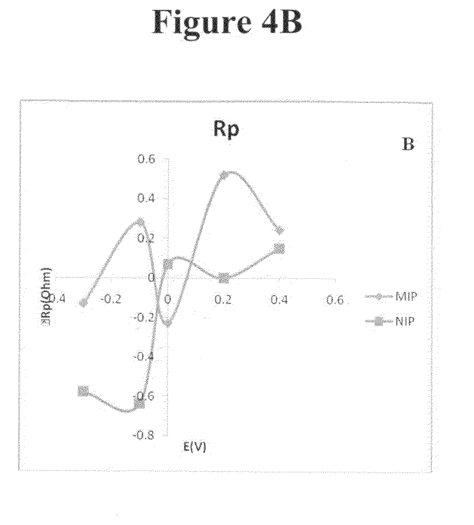

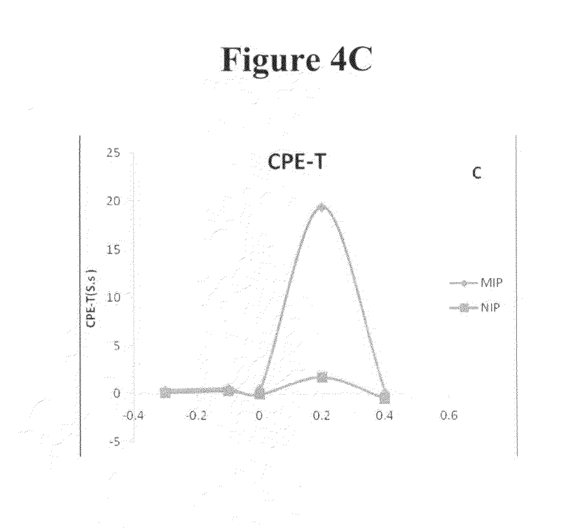

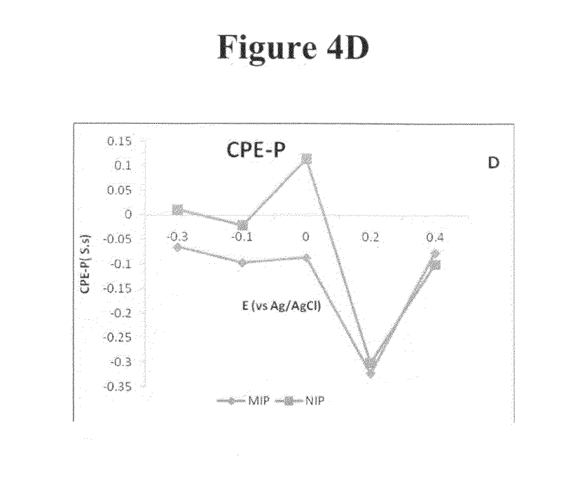

The equivalent circuit was verified by comparing simulated spectra with that of a patulin-polypyrrole modified glassy carbon electrode (FIG. 3B). From equivalent circuit analysis it was possible to determine the change in each element upon interaction of the polypyrrole film with patulin. From comparing the results, differences between patulin polypyrrole films and non-patulin films were observed. The solution resistance (Rs) progressively increased with bias potentials in patulin films following the addition of patulin (FIG. 4A) With non-patulin films the Rs remained relatively static within the potential range of −0.1-0.2 V vs Ag/AgCl although increased at 0.3V (FIG. 4B). The differences between the Rs change in patulin and non-patulin films indicates a higher affinity of the patulin films to patulin.

The change in polymer resistance (Rp) upon addition of patulin fluctuated depending on the applied bias potential (FIG. 4B). At reducing potentials −0.3 V vs Ag/AgCl no notable change in Rp occurred although as the film became oxidized (0.2-0.4) the presence of patulin increased the measured resistance possibly through interacting with bipolarons. This is supported by the decrease in Rp recorded at 0V where polarons but not bipolarons, are favoured In non-patulin films, there was a decrease in resistance at negative bias potentials. This indicates that the polarons on the polypyrrole chains were oxidized via patulin (FIG. 4B). As the bias potential increased the Rp changes in non-patulin films became negligible. Therefore, these results also indicate that patulin films exhibited a higher affinity towards the mycotoxin compared to non-patulin polypyrrole. This higher affinity is most likely dependent on the ability of patulin to diffuse into the film.

The change in CPE-T with both patulin and non-patulin polypyrrole was independent of bias potential except at 0.2V vs Ag/AgCl. The CPE-T is an indirect measure of the film capacitance and the higher change in the patulin film compared to the non-patulin control suggested that the interaction with patulin increased the capacitive (dielectric) character of the film (FIG. 4C). This was supported by the decrease in CPE-P at 0.2V which represents the ion diffusion within the film (FIG. 4D). Changes in CPE-P were also observed in non-patulin polypyrrole although were inverse of the patulin film between bias potentials of −0.3-0 V vs Ag/AgCl (FIG. 4D).

The results suggest that the interaction of patulin with polypyrrole is most likely via formation of covalent linkages. It is known that patulin can be reduced via a free radical mechanism by ascorbic acid or disulphide bonds acting as electron donors. Therefore, it is likely that. the polarons and bipolarons on the polypyrrole backbone act as electron donors given their strong anti-oxidant properties. Interaction of patulin with polarons would result in the formation of bipolarons and hence increased conductivity.

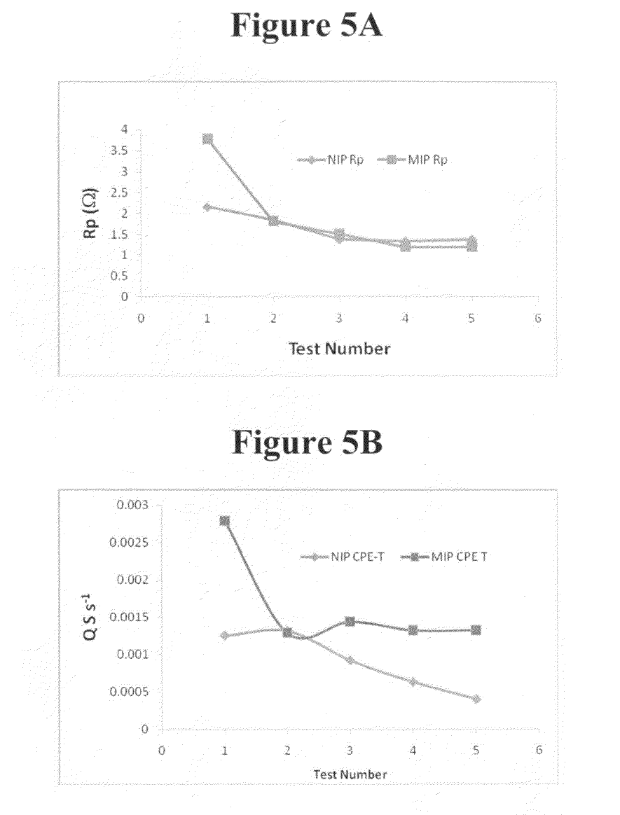

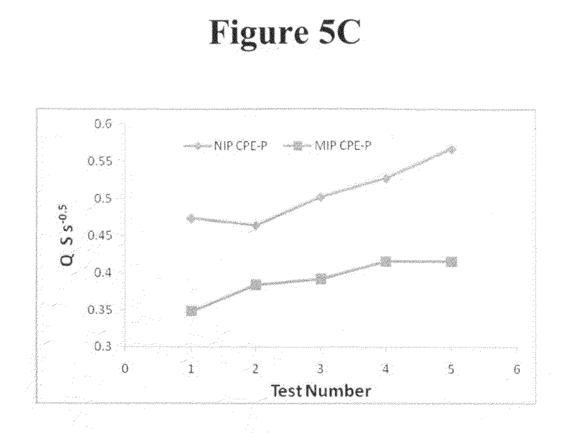

To test this hypothesis a patulin and non-patulin polymer film was repeatedly exposed to patulin (100 ppb) at a potential of 0.2V vs Ag/AgCl, and changes in the baseline circuit elements determined (FIG. 5). To account for ionic interactions the film was submerged in TEA (3% v/v) to elute non-covalently bound patulin. From the impedance spectra, there was a decrease in Rp and CPE-T values for both patulin and non-patulin films (FIG. 5). The patulin films exhibited a decrease followed by a plateau region upon additional exposure to patulin. The CPE-P increased progressively between each patulin addition for both films.

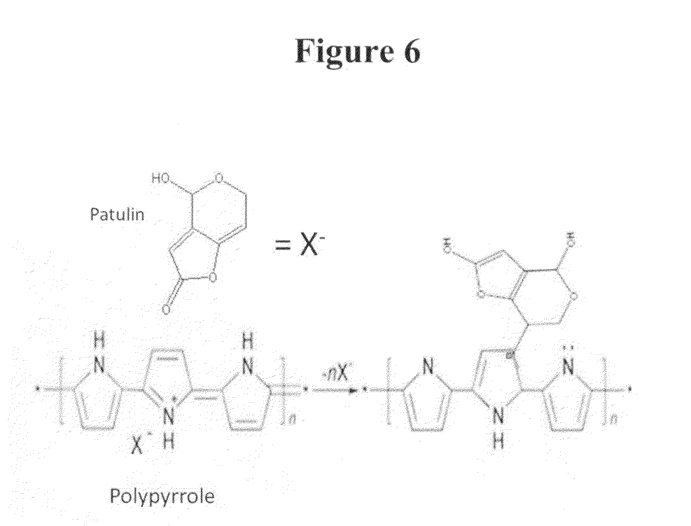

The results evidence that patulin forms covalent bonds with polypyrrole given that the circuit element values did not return to baseline values following regeneration (i.e. the reaction was irreversible). A schematic diagram of the reaction scheme for patulin:polypyrrole reaction is illustrated in FIG. 6. Direct evidence of this reaction was obtained using UV and ATR-FTIR spectroscopy. The general principle of UV spectroscopy is to measure the transmission or absorption of light delivered at different wavelengths through the sample. As the light passes through the sample the photons can be absorbed by certain bonds depending on the applied wavelength. UV spectroscopy was undertaken to prove the structure of polypyrrole:patulin adducts. Patulin (5 mg) was reacted with 1 ml aqueous pyrrole (5 mg) solution with ferric chloride (0.1 mM) as oxidant. Polymerization was allowed to processed at room temperature (ca. 23° C.) for 30 min with the UV spectra (280-450 nm) being taken periodically. In parallel, pyrrole was polymerized in the absence of patulin to provide background spectra. By subtracting the background spectra from that of patlin:polypyrrole there were several peaks identified centered around 280 and 450 nm indicative of bond formation. The emergence of new bonds provides evidence of bond which again would support the reaction scheme highlighted in FIG. 6.

Attenuated total reflectance infrared spectroscopy (ATR-FTIR) studies were undertaken to further probe the nature of the bonds formed between patulin and polypyrrole. The experiment described above for UV spectroscopy was performed with the infrared spectrum being recorded. Of specific interest was the increase in the 1740 cm⁻¹ peak which was indicative of ester bond formation. This provided yet further evidence to support the reaction scheme between pyrrole and patulin illustrated in FIG. 1.

From the impedance and spectroscopic data it can be concluded that the observed response of the sensor to patulin was due to adduct formation. The greater response of the patlin:polypyrrole film relative to the non-patulin film was likely due to the higher porosity of the former which enabled enhanced diffusion of the mycotoxin into the inner conducting polymer matrix. In contrast, the polymer chains within plain polypyrrole results in restricted diffusion of patulin and although adduct formation still occurs this is restricted to the polymer:solution interface. Consequently, the observed electrochemical changes in polypyrrole are negligible.

### EXAMPLE 2

### Detection of Patulin in Apple Juice

The following experiment was undertaken to determine if the sensor could detect patulin spiked into re-constituted apple juice. Apple juice represents a complex matrix consisting of organic acids (malic, citric), in addition to reducing agents such as ascorbic acid and phenolic compounds all of which could potentially interact with polypyrrole, and lead to interference.

Sensors were prepared by depositing patulin (1 ppm) onto the surface of glassy carbon electrodes followed by electropolymerization of pyrrole. The impedance spectra of the films was determined across a frequency range of 0.1-100,000 Hz with an applied DC bias potential of 0.2 V (vs Ag/AgCl) and imposed AC potential amplitude of 40 mV. The spectra generated were converted to admittance (Y″) with the reflection (Y″ₘᵢₘᵢₘᵤₘ) being recorded.

After collecting the background spectra, the sensor was removed from the electrochemical cell and rinsed with triethylamine. Aliquots, 20 μl patulin (100 ppb in water or reconstituted apple juice; 7.0 Brix) were dispensed onto the surface of the film and allowed to react for 10 min at room temperature (ca. 23° C.). The sensor was then returned to the electrochemical cell and the spectra collected with the response being represented by subtracting the Y″ minima of the background values. The response of 10 individual sensors to 100 ppb patulin was recorded, in addition to the response of a further 10 sensors to water or apple juice to determine the contribution of sample constituents. The average response of the latter was determined and the level of detection set at three times this value (i.e. signal:noise ratio).

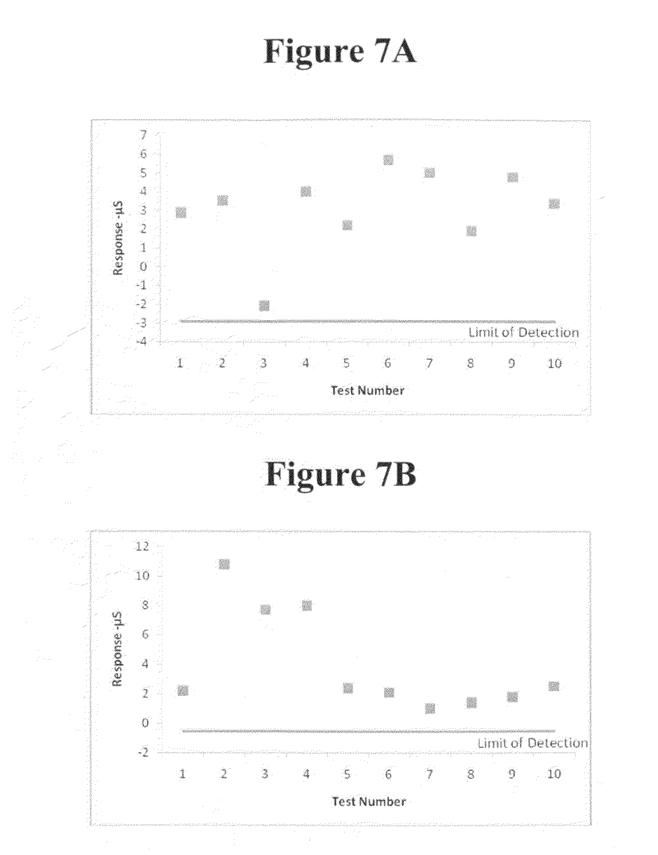

With water alone, film conductivity increased and with an average response (Y″signal-Y″_{background}) of 3.1 μS. As previously observed, when reacted with patulin in water the conductivity of the supporting conducting polymer film decreased. The sensor response to patulin in water was relatively stable and consistent (FIG. 7A). When measurements were performed in apple juice the baseline value was higher compared to water which was likely due to the presence of interfering constituents (such as ascorbic acid and/or organic acids) within the matrix (FIG. 7B). Nevertheless, the sensor could still detect 100 ppb with no false-negative results being recorded.

### EXAMPLE 3

### Detection of DON on Modified Conducting Polymer Films

Electrodes were fabricated by depositing 20 μl of 0.1-1% w/v DNA or BSA solution on the surface of glassy carbon electrodes. Polypyrrole was then galvinostatically (0.8V vs Ag/AgCl, 70 μC) electropolymerized from a 0.1M pyrrole solution containing 0.5M NH₄Cl. The electrode was rinsed with distilled water and conditioned overnight at room temperature. Cyclic voltammograms of modified electrodes produced high capacitive currents with no discernable oxidation/reduction peaks. Therefore, differential pulse voltammetry (DPV) was applied which essentially enables the faradic current to be measured even in the presence of a high capacitive background.

Baseline studies developed sensors using combinations of polypyrrole and DNA. DNA was deposited at different concentrations (0.1-1%) onto the electrode surface prior to polymerization or added onto the surface of polypyrrole. The modified films were sequentially exposed to different concentrations of acradine orange (surrogate for mycotoxins) with electrochemical interrogation being performed following each exposure.

From the results obtained, the optimal response for polypyrrole:acradine orange modified electrodes was achieved by depositing 20 μl of 0.1% w/v DNA on the surface of electrodes followed by electropolymerization of pyrrole. From differential pulse voltammograms (corrected for background) of DNA:polypyrrole modified electrodes a clear oxidation peak was observed at 0.25 V vs Ag/AgCl which was not present on blank polypyrrole films. This indicates that the observed electrochemistry was occurring via the interaction of acradine orange with DNA. The response of the electrode could be correlated to acradine orange concentration with a detection limit of 5 mM.

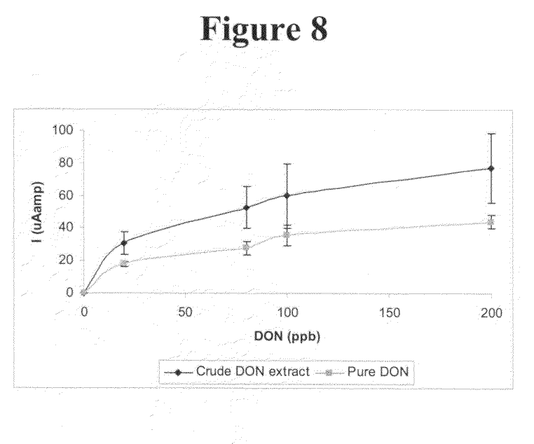

When DNA:polypyrrole films were reacted with different concentrations of DON an oxidation peak was observed but displaced to −0.2V vs Ag/AgCl. In addition, polypyrrole alone without DNA gave a similar response suggesting that electrochemistry was directly occurring on the conducting polymer backbone as opposed to through the DNA. A crude extract of DON was prepared by cultivating Fusarium graminearum on beds of rice for 4 weeks at 25° C. Upon completion of the cultivation period the DON was extracted using a combination of methanol extraction and filtration. DON was concentrated using rotary evaporation and the final concentration determined by HPLC analysis (328 ppm). A dilution series was prepared in weak acetic acid solution to give standards ranging from 20-200 ppb. Dose response curves of the crude extract obtained at a DNA: polypyrrole modified electrode followed the same trend as when pure DON mycotoxin was applied (FIG. 8).

Further trials were performed using polypyrrole-modified with BSA. In this case the optimal response was recorded when the BSA was deposited on the surface of the polypyrrole as opposed to underlying glassy carbon electrode. When reacted with DON the oxidative peak current decreased suggesting that reducing groups on the BSA had occurred during the interaction with the mycotoxin. Alternatively, it is possible that the changes in polypyrrole conductivity were due to protein:conducting polymer interactions. The extent of the reduced current could be correlated to DON toxin with a lower detection limit of 5 ppb (FIG. 8).

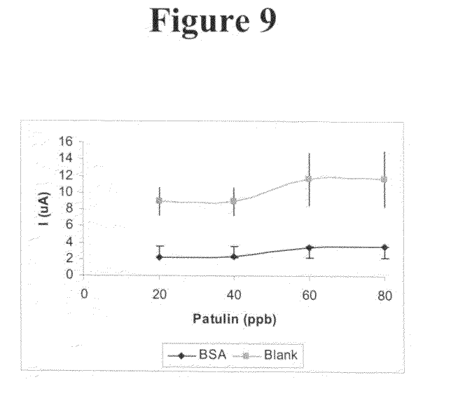

The ability of the BSA sensors to detect patulin was also evaluated and responses were detected on polypyrrole:BSA modified electrodes (FIG. 9). The oxidation current was significantly lower for polypyrrole:BSA films compared to polypyrrole alone.

The results suggest that DNA or BSA modified polypyrrole electrodes can provide sensitive detection of mycotoxins.

We claim:

1. A biosensor for detecting one or more electrophilic compounds, comprising a conducting polymer and a facilitating agent that combine to form a polymeric matrix that interacts with electrophilic compounds, wherein the interaction with an electrophilic compound induces a change in an electrochemical property of the polymer.

2. A biosensor as defined in claim 1, wherein the conducting polymer is selected from the group consisting of polypyrrole, polyaniline, polythiophene, polyacetylene, and derivatives thereof.

3. A biosensor as defined in claim 2, wherein the facilitating agent is selected from the group consisting of patulin and derivatives thereof, compounds having a molecular weight >150, pyrrole derivatives, nucleophilic compounds that react with an electrophilic compound to be detected, nucleic acids, proteins, cysteine and tyrosine.

4. A biosensor as defined in claim 3, wherein the facilitating agent is patulin.

5. A biosensor as defined in claim 1, wherein the facilitating agent is bovine serum albumin.

6. A biosensor as defined in claim 1, wherein the facilitating agent is DNA.

7. A biosensor as defined in claiml, wherein the electrochemical property is conductivity.

8. A biosensor as defined in claim 1, wherein the electrophilic compound is a mycotoxin.

9. A biosensor as defined in claim 8, wherein the mycotoxin is selected from the group consisting of an aflatoxin, ochratoxin A, patulin and a fusarium toxin.

10. A method of detecting a target electrophilic compound in a sample comprising the steps of:
1) contacting the sample with a biosensor comprising a conducting polymer and a facilitating agent that combine to form a polymeric matrix that interacts with electrophilic compounds to induce a change in an electrochemical property of the polymer; and
2) determining whether an electrochemical property of the polymer is altered, wherein a change in an electrochemical property of the polymer is indicative of the presence of an electrophilic compound in the sample.

11. A method as defined in claim 10, wherein the biosensor comprises a conducting polymer selected from the group consisting of polypyrrole, polyaniline, polythiophene, polyacetylene, and derivatives thereof.

12. A method as defined in claim 10, wherein the biosensor comprises a facilitating agent selected from the group consisting of patulin and derivatives thereof, compounds having a molecular weight >150, pyrrole derivatives, nucleophilic compounds that react with an electrophilic compound to be detected, nucleic acids, proteins, cysteine and tyrosine.

13. A method as defined in claim 10, wherein the electrochemical property is conductivity.

14. A method as defined in claim 13, wherein a decrease in conductivity is indicative of the presence of an electrophilic compound in the sample.

15. A method as defined in claim 10, wherein the electrophilic compound is a mycotoxin.

16. A method as defined in claim 15, wherein the mycotoxin is selected from the group consisting of an aflatoxin, ochratoxin A, patulin and a fusarium toxin.

17. A method as defined in claim 10, wherein the change in the electrochemical property of the polymer is proportional to the amount of the electrophilic compound in the sample.

18. A method as defined in claim 10, for detecting an electrophilic compound at a limit of less than 100 ppb.

19. A biosensor as defined in claim 1, wherein the interaction results in the formation of an adduct.
